(19) United States
(12) Patent Application Publication
(10) Pub. No.: US 2011/0184770 A1
(43) Pub. Date: Jul. 28, 2011

(54) CROSS DOCKING IN ROUTE DETERMINATION

(76) Inventors: Winfried Schwarzmann, Waghaeusel (DE); Arno Diego Bruns, Walzbachtal (DE); Amar Kumar, Neulussheim (DE)

(21) Appl. No.: 12/096,558

(22) PCT Filed: Dec. 7, 2005
(86) PCT No.: PCT/EP05/56570

§ 371 Date: Dec. 15, 2010

(51) Int. Cl. G06Q 10/00

(52) U.S. Cl. 705/7.11

(57) ABSTRACT

Apparatus comprising a data storage device which stores at least one route graph, the at least one route graph describing a plurality of route paths between a plurality of locations, wherein at least one route path in the at least one route graph comprises at least two consecutive direct routes connected by a cross-docking location, the at least one route path connecting a first location with a second location, the cross-docking location in combination with the connected at least two direct routes building up a cross-docking route; the route graph comprising at least one cross-docking route; wherein the apparatus determines at least one transportation route from a source location to a destination location using at least one cross-docking route, a source location and a destination location, the at least one cross-docking route describing at least one of a local graph of direct routes and a global graph of direct routes.

### BACKGROUND OF THE INVENTION

The present invention relates to apparatus and methods for planning and describing route paths in route graphs. More particularly, the present invention relates to apparatus and methods for describing transportation routes in a route graph for planning and executing transport processes within a supply chain management system.

Supply chain management may comprise the process of coordinating the flow of goods, services, information and/or finances between the involved parties such as manufactures, suppliers, wholesalers, retailers, and consumers. This process may include, among others, order processing, information feedback, and timely delivering the ordered goods and/or services. One important aspect of supply chain management is the planning of transportation routes.

### STATE OF THE ART

A transportation route represents a system response to a transportation request. A transportation request consists of at least the source location (S) and the destination location (D). In current supply chain management systems a transportation route is described as part of a single direct route. A direct route is master data with a unique identifier (ID). It consists of a sequence of legs. A leg is a combination of at least one means of transportation and a set of locations. Consecutive legs are linked by locations at which transshipping, for example changing means of transportation, takes place. Therefore, a direct route allows the determination of multimodal transportation routes. Since there exists at most one transportation route between S and D based on a direct route, the transportation route can be identified by the ID of that direct route for a given transportation request.

### SUMMARY

In general, in one aspect, this invention provides an apparatus comprising:
a data storage device which stores at least one route graph, the at least one route graph describing a plurality of route paths between a plurality of locations, wherein at least one route path in the at least one route graph comprises at least two consecutive direct routes which are connected by a cross-docking location and wherein the at least one route path connects a first location with a second location, wherein
   the cross-docking location in combination with the connected at least two direct routes builds up a cross-docking route;
   the route graph comprises at least one cross-docking route;
   the at least one route path is specified by the cross-docking route, the first location and the second location; and
wherein the apparatus determines at least one transportation route from a source location to a destination location using at least one cross-docking route, a source location and a destination location wherein the at least one cross-docking route describes at least one of a local graph of direct routes and a global graph of direct routes.

Further embodiments of the invention can comprise the following features.

The apparatus further may comprise means for
defining a transportation route by a cross-docking route, a source location and a destination location;
defining a plurality of direct routes;
defining at least one cross-docking location; and
defining at least one cross-docking route by connecting at least two direct routes by the at least one cross-docking location.

Further, the apparatus may comprise means for connecting at least a further cross-docking route by the cross-docking location.

A cross-docking route may describe a local graph of direct routes with respect to the cross-docking location.

The at least one direct route may be an incoming route with respect to the cross-docking location and at least one direct route may be an outgoing route with respect to the cross-docking location.

Furthermore, a plurality of cross-docking routes may describe a global graph of direct routes, wherein the plurality of cross-docking routes are connected together.

The incoming route may be a cross-docking route and the outgoing route may be a cross-docking route.

Further, a cross-docking route may describe a hierarchy of routes, wherein the relationship between a cross-docking route and the incoming and outgoing routes is a parent-child relationship.

Yet further, a parent within the hierarchy of routes may comprise a number of properties wherein each child with respect to the parent being able to take over the properties of the parent.

In one embodiment of the invention, each direct route may comprise at least one leg, wherein a leg comprises at least a set of locations and a means of transportation.

Further, the first location may be a source location of a transportation request and the second location may be a destination location of the transportation request.

A route path may represent a transportation route from the source location to the destination location of the transportation request.

Furthermore, a cross-docking location may be part of several cross-docking routes and a route may be part of several cross-docking routes.

In one embodiment of the invention, a cross-docking route may allow transportation of goods from a source location to a destination location along the transportation route wherein the transportation route comprises at least the cross-docking-route.

Further, a cross-docking route may comprise a number of properties for a pair of incoming and outgoing routes indicating whether or not goods on a transportation means arriving at the cross-docking location on the incoming route have to be reloaded on a different transportation means when leaving the cross-docking location on the outgoing route.

In second aspect the invention provides a route graph for describing a plurality of route paths between a plurality of locations, wherein at least one route path in the route graph comprises at least two consecutive direct routes which are connected by a cross-docking location and wherein the at least one route path connects a first location with a second location, wherein
the cross-docking location in combination with the connected at least two direct routes builds up a cross-docking route;
the route graph comprises at least one cross-docking route; and
the at least one route path is specified by the cross-docking route, the first location and the second location.

Furthermore, the invention provides a computer-implemented method for representing transportation routes in a route graph, comprising at least a step of determining at least one transportation route between a source location S and destination location D using at least one cross-docking route, wherein the at least one cross-docking route describes at least one of a local graph of direct routes and a global graph of direct routes.

Further, the method may comprise steps of:
defining a plurality of direct routes;
defining at least one cross-docking location; and
defining at least one cross-docking route by connecting at least two direct routes by the at least one cross-docking location.

Yet further, the method may comprise steps of
receiving a transportation request comprising at least a source location S and a destination location D; and
issuing a response to the transportation request comprising at least the source location S, the destination location D and a cross-docking route.

The method may comprise a step of specifying at least one cross-docking route by connecting at least a further cross-docking route by the cross-docking location.

Furthermore, the determined transportation route may comprise a sequence of direct routes.

In one embodiment of the invention, the method may comprise steps of maintaining at least one local route graph and maintaining at least one global route graph, wherein the authority for maintaining the at least one local route graph is disjunctive to the authority for maintaining the at least one global route graph.

Furthermore, the invention provides a computer-readable medium comprising computer-executable instructions for performing the inventive method, when loaded into a computer system.

The present invention is linked with many advantages.

One advantage is that the present invention allows the definition of route graphs. For any transportation request the route determination is able to return the entire transportation path as a sequence of direct routes. This allows the warehouse to consolidate based on the single information of the name of the (direct) route leaving the warehouse (first route of the paths). On the other hand, the present invention allows representing the entire transportation paths by not more than one cross-docking route identifier plus both the source and destination location.

Further, the introduction of route graphs allows to reuse routes and thus to keep the number of direct routes as small as possible. This may reduce the efforts for both route creation and maintenance and no data has to be duplicated and maintained simultaneously. As a consequence, the data volume on the data storage device may be reduced.

Yet further, the present invention allows configuring in detail the transportation options. It allows distinguishing between local and global connections of routes. A global connection of routes consists of at least one local connection of routes. It offers more transportation options, but increases the inherent complexity of the route determination. The invention allows the user to balance this dualism. As an additional aspect, the output of the route determination is not purely based on costs. With this distinction the invention allows to assign different authorities for maintaining local and global connections of routes.

### BRIEF DESCRIPTION OF DRAWINGS

The accompanying drawings, which constitute a part of this disclosure, illustrate various embodiments and aspects of the present invention and, together with the description, explain the principles of the invention. In the drawings:

FIG. 1a illustrates transportation routes with direct routes;

FIG. 1b illustrates transportation routes with a route graph;

FIG. 2a illustrates a cross-docking route;

FIG. 2b illustrates a hierarchy of routes;

FIG. 3a illustrates two independent cross-docking routes with the corresponding route hierarchies;

FIG. 3b illustrates a route graph with the corresponding route hierarchy;

FIG. 4 illustrates a more complex route graph; and

FIG. 5 illustrates a block diagram according to the inventive method.

### DETAILED DESCRIPTION

Transportation routes are important for planning and execution of warehouse processes. For example, if two deliveries are assigned to transportation routes based on the same route, then it depends on the delivery date and therefore the goods issue date whether or not they go on the same vehicle. Routes are defined from suppliers to warehouses, from warehouses to customers and also between warehouses. If there does not exist a direct route from a source location, for example a supplier, to a destination location, for example a customer, then products may be shipped through intermediate locations. These intermediate locations are denoted as cross-docking locations.

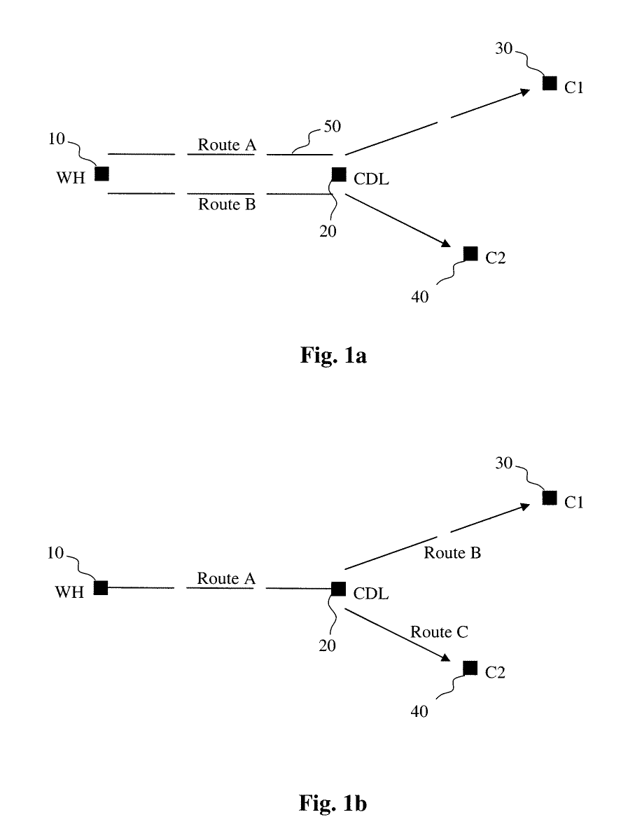

FIG. 1a shows two direct routes. The direct route Route A connects the warehouse WH 10 with the customer C1 30. The direct route Route B connects the warehouse WH 10 with the customer C2 40. The routes have to pass the cross-docking location CDL 20. Route A consists of five legs 50—three legs between the warehouse WH 10 and the cross-docking location CDL 20 and two legs between the cross-docking location CDL 20 and the customer C1 30. Route B consists of four legs 50—three legs between the warehouse WH 10 and the cross-docking location CDL 20 and one leg between the cross-docking location CDL 20 and the customer C2 40.

A leg is a combination of at least one means of transportation and a number of locations. For example, on the first leg 50 products may be transported by train, on the second leg 50 by ship, and on the final leg to CDL 20 by truck. Every means of transportation serves as a representative for actual vehicles. A location may be a specific location as well as a simple address.

As shown in FIG. 1a, the first part between the warehouse WH 10 and the cross-docking location CDL 20 of the Routes A and B are identical. The first part of the routes has to be maintained twice even if they are identical. This situation may be prevented by splitting both Routes A and B and merging the first part of the Routes A and B into one single route.

The result is shown in FIG. 1b. This figure shows a route graph comprising three direct routes Route A, Route B and Route C. The first direct route Route A connects the warehouse WH 10 with the cross-docking location CDL 20, direct route Route B connects the cross-docking location CDL 20 with the customer C1 30, and direct route Route C connects the cross-docking location CDL 20 with the customer C2 40. In order to transport products from warehouse WH 10 to customer C1 30, the direct route Route A in connection with direct route Route B has to be used. Modeling a route graph comprising three direct routes instead of modeling two independent direct routes (as shown in FIG. 1a) for the transportation routes avoids the multiple definition of the same routes or at least the multiple definition of parts thereof. This leads to a significant reduction of the data volume in the data storage and to a reduction of the maintenance effort. According to the FIG. 1a nine legs have to be stored in the data storage whereas according to the FIG. 1b only six legs have to be stored. Furthermore the warehouse WH 10 has to handle with only one route instead of two routes which lead to the same cross-docking location first. Thus, the complexity of the consolidation process may be reduced.

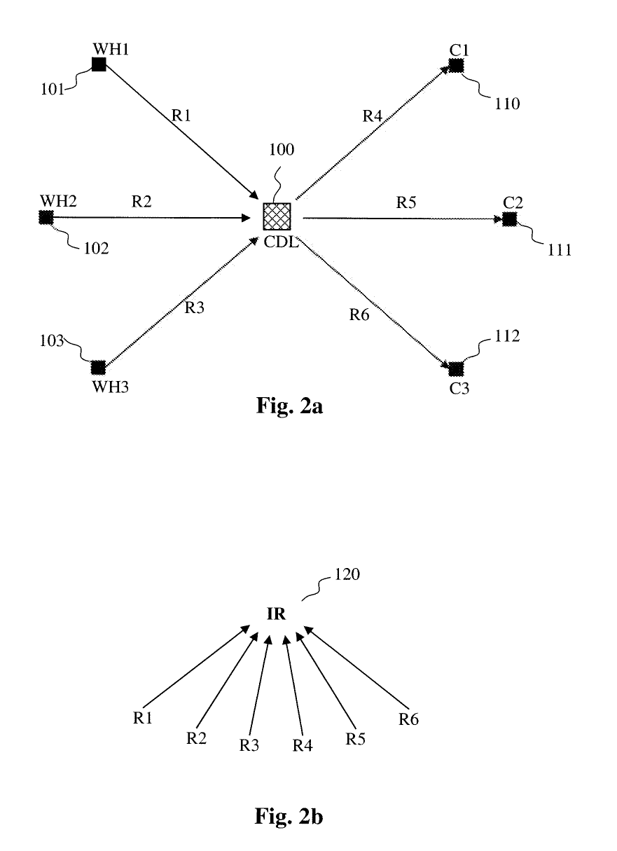

FIG. 2a shows an example of a cross-docking route at a cross-docking location CDL 100. A cross-docking route at a cross-docking location comprises a number of incoming direct routes R1, R2, R3 and a number of outgoing direct routes R4, R5, R6. In this example, the incoming direct routes R1, R2 and R3 are direct routes from the warehouses WH1 101, WH2 102 and WH3 103 to the cross-docking location CDL 100. The outgoing direct routes R4, R5 and R6 are direct routes from the cross-docking location CDL 100 to the customers C1 110, C2 111 and C3 112. Cross-docking routes enable transportation from locations 101, 102, 103 to locations 110, 111, 112. According to this example, nine different transportation routes are possible by defining the cross-docking route at the cross-docking location CDL 100 comprising three incoming and three outgoing direct routes. In order to have the same functionality without cross-docking routes, it would be necessary to define nine direct routes between each of the locations 101, 102 and 103 and each of the locations 110, 111 and 112.

A cross-docking route is internally represented as a hierarchy of routes, as shown in FIG. 2b. The parent node IR 120 (also denoted as parent route IR) represents the cross-docking route defined in FIG. 2a for the cross-docking location CDL 100. The parent node IR 120 has a number of child nodes R1 to R6, from which parent-child-relationships 121 are depicted from the child to the parent. In FIG. 2b the child nodes represent direct routes. At least one of the child nodes is an incoming child node R1, R2, R3 and at least one of the child nodes is an outgoing child node R4, R5, R6. The direction of the child nodes (incoming or outgoing) may be stored with the corresponding parent-child-relationship.

A cross-docking route may represent a local view of direct routes with respect to a cross-docking location. An employee at a cross-docking location may describe a cross-docking route with respect to the cross-docking location by defining just the incoming direct routes and the outgoing direct routes. Within the route graph spanned by a cross-docking route the transportation route from a source to a destination location is uniquely defined. If all children of a cross-docking route are direct routes, then its route graph is called a local route graph.

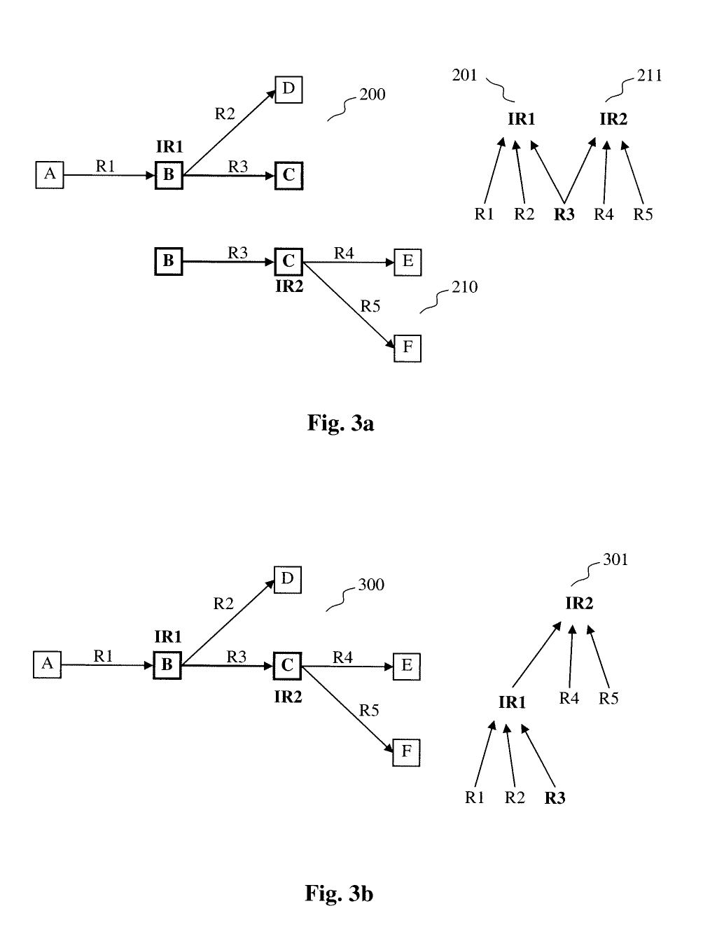

With several cross-docking routes a more complex (global) route graph can be build. This can be achieved by connecting several cross-docking routes. FIG. 3a shows two independent cross-docking routes 200 and 210. The cross-docking routes 200, 210 also represent two local route graphs. The cross-docking route 200 is defined by a first employee with respect to the cross-docking location B. For this he needs only information about the incoming and outgoing direct routes with respect to cross-docking location B. The same or another employee defines the local route graph 210. For this he needs only information about incoming and outgoing direct routes with respect to the cross-docking location C.

Therefore, location E can be only reached from location B and location C but not from location A. The hierarchies of both local graphs are shown by items 201 and 211. The hierarchy 201 represents the cross-docking route 200 at cross-docking location B, and hierarchy 211 represents the cross-docking route 210 at cross-docking location C. As shown in FIG. 3a, in both cross-docking routes 200 and 210 the location B is connected by direct route R3 with location C. This is also shown in the hierarchies, where the direct route R3 is a common child of the cross-docking routes IR1 and IR2.

In order to describe a route graph in which location E is reachable from location A, both local route graphs 200, 210 have to be connected to a new route graph. The new route graph describes a global route graph. Connecting local route graphs may be performed, for example, by a supervisor, who has enough information about the local route graphs to be connected. In this example, a supervisor may connect the local route graph by defining the cross-docking route 200 as an incoming route with respect to the cross-docking route 210. The result is the global route graph 300 shown in FIG. 3b. After connecting the local route graphs 200, 210, location E can be reached from locations A, B and C. The respective route hierarchy is shown in 301. The hierarchy of cross-docking route 210 has the cross-docking route 200 as a child.

The parent routes IR1 and IR2 within the hierarchy of FIG. 3b may comprise several properties which describe a number of settings for the cross-docking location and/or its incoming or outgoing direct routes. One setting may be whether or not a transport has to be reloaded at the location. These properties may be propagated from the parent to the respective children wherein each child can decide to take over or not the properties.

In one embodiment of the inventive method, the maintenance of the local and global route graphs may depend on the authorization of the user defining the route graphs. For example, the authorization for maintaining a part of the local route graph may be disjunctive to the authorization for maintaining a part of the global route graph.

Furthermore, a transportation route from a source location S to a destination location D can be uniquely defined as (S, IR, D), wherein IR represents a cross-docking route at a cross-docking location.

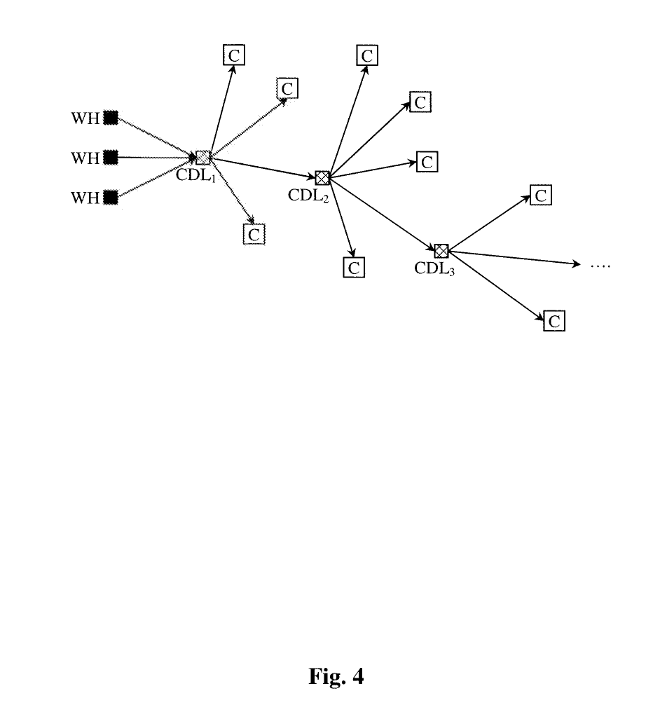

FIG. 4 shows a complex route graph, comprising three warehouse locations (WH) and three cross-docking locations CDL₁ to CDL₃ and several customer locations (C). Within a route graph, like this complex route graph, direct routes are part of multiple transportation routes. For example, the direct route which connects a warehouse WH with the first cross-docking location CDL₁, may be defined only once even if several transportation routes diverge afterwards. The number of direct routes can be reduced to a minimum and therefore the amount of data in the data storage can be minimized.

The warehouse locations (WH) describe several source location and the customer locations (C) describe several destination locations. The inventive method supports request of transportation routes between these source locations and destination location. Furthermore, the inventive method also supports requests of transportation routes wherein the source location or the destination location of the request may be located within the route graph. For example, requests with cross-docking location CDL₁ as source location and cross-docking location CDL₂ as destination location are also supported.

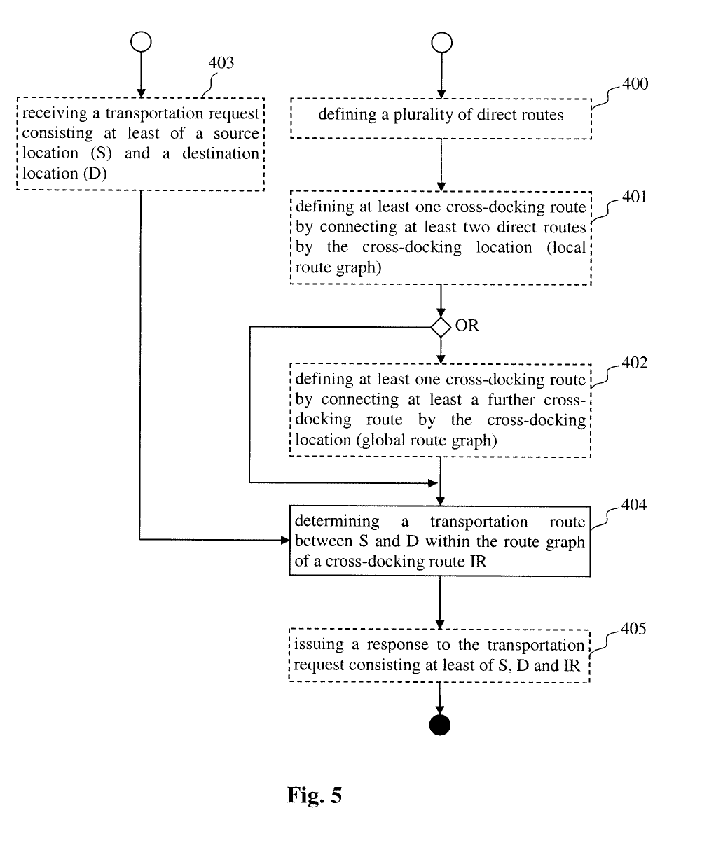

The block diagram according to FIG. 5 illustrates the inventive method. The method starts with a step 400 of defining a plurality of direct routes. Within this first step 400 several cross-docking locations may be defined.

Continuing with step 401 at least one cross-docking route may be defined as described above in FIG. 2. That way, local route graphs can be built. In a further embodiment of the invention, the steps 400 and 401 may be performed as a single step.

Optionally, continuing with step 402 at least one cross-docking route may be defined as described above in FIG. 3. That way, global route graphs can be built. In one embodiment of the invention, the method may end (not shown in this figure) after the steps 401 or 402. In a further embodiment of the invention, the method proceeds after step 401 or 402 with the step 403.

The defined direct routes and the cross-docking routes are stored in a database for further processing. Processing comprises, for example, editing direct routes, editing cross-docking routes or building up further cross-docking routes. Editing cross-docking routes may include, for example, defining or changing properties of the cross-docking routes.

In a supply chain management system more than one route graph may be defined. For example, a first route graph for emergency transports and a second route graph for normal transportations may be defined.

The method may also start with step 403. With step 403 the method receives a transportation request comprising at least a source location S and a destination location D. It proceeds with determining a transportation route out of the defined route graphs within step 404. Therefore, the result of step 404 is influenced by step 401 or step 402, but does not need to follow them directly.

Finally, the method ends by issuing a response to the transportation request. This response may comprise at least the source location S, the destination location D and a cross-docking-route. The route graph of the cross-docking-route comprises the determined transportation route completely.

In one embodiment, steps 400 to 402 may be independent of the steps 403 to 405. In this case step 401 or 402 are not followed by one of the steps 403 to 405. Determining transportation routes may be done, for example, by a warehouse employee in order to plan the transport of ordered products from the warehouse to the customer.

After planning the transport from the warehouse to the customer the planned transport is updated with at least the unique route identifier of the determined cross-docking route. Since the unique route ID describes the complete transportation path from the source location to the destination location, the transportation route can be re-determined at any time.

In one embodiment, transportation routes are not stored within the above mentioned database. A transportation route may be determined at run time of a transportation route request. In a further embodiment, transportation routes, for example transportation routes which are frequently requested, may be stored permanently within the database in order to reduce the system load.

The present techniques can be implemented in digital electronic circuitry, or in computer hardware, firmware, software, or in combinations of them. Apparatus of the invention can be implemented in a computer program product tangibly embodied in a machine-readable storage device for execution by a programmable processor. Method steps according to the invention can be performed by a programmable processor executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

The computer systems or distributed computer networks as mentioned above may be used, for example, for producing goods, delivering parts for assembling products, controlling technical or economical processes, or implementing telecommunication activities.

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. An apparatus comprising:
a data storage device which stores at least one route graph, the at least one route graph describing a plurality of route paths between a plurality of locations, wherein at least one route path in the at least one route graph comprises at least two consecutive direct routes which are connected by a cross-docking location and wherein the at least one route path connects a first location with a second location, wherein
the cross-docking location in combination with the connected at least two direct routes builds up a cross-docking route;
the route graph comprises at least one cross-docking route;
the at least one route path is specified by the cross-docking route, the first location and the second location; and
wherein the apparatus determines at least one transportation route from a source location to a destination location using at least one cross-docking route, a source location and a destination location wherein the at least one cross-docking route describes at least one of a local graph of direct routes and a global graph of direct routes.

2. The apparatus of claim 1, further comprising:
means for defining a transportation route by a cross-docking route, a source location and a destination location;
means for defining a plurality of direct routes;
means for defining at least one cross-docking location; and
means for defining at least one cross-docking route by connecting at least two direct routes by the at least one cross-docking location.

3. The apparatus of claim 1, further comprising:
means for connecting at least a further cross-docking route by the cross-docking location.

4. The apparatus of claim 1, wherein a cross-docking route describes a local graph of direct routes with respect to the cross-docking location.

5. The apparatus of claim 4, wherein at least one direct route is an incoming route with respect to the cross-docking location and at least one direct route is an outgoing route with respect to the cross-docking location.

6. The apparatus of claim 5, wherein a plurality of cross-docking routes describe a global graph of direct routes, that connect together the plurality of cross-docking routes.

7. The apparatus of claim 6, wherein the incoming route is a cross-docking route.

8. The apparatus of claim 7, wherein the outgoing route is a cross-docking route.

9. The apparatus of claim 8, wherein a cross-docking route describes a hierarchy of routes, wherein the relationship between a cross-docking route and the incoming and outgoing routes is a parent-child relationship.

10. The apparatus of claim 9, wherein a parent within the hierarchy of routes has a number of properties such that each child with respect to the parent is able to take over the properties of the parent.

11. The apparatus of claim 10, wherein each direct route comprises at least one leg, wherein a leg comprises at least a set of locations and a means of transportation.

12. The apparatus of claim 11, wherein the first location is a source location of a transportation request and the second location is a destination location of the transportation request.

13. The apparatus of claim 12, wherein a route path represents a transportation route from the source location to the destination location of the transportation request.

14. The apparatus of claim 13, wherein a cross-docking location is part of several cross-docking routes.

15. The apparatus of claim 14, wherein a route is part of several cross-docking routes.

16. The apparatus of claim 15, wherein a cross-docking route allows transportation of goods from a source location to a destination location along the transportation route, wherein the transportation route comprises at least the cross-docking-route.

17. The apparatus of claim 16, wherein a cross-docking route comprises a number of properties for a pair of incoming and outgoing routes indicating whether or not goods on a transport arriving at the cross-docking location on the incoming route have to be reloaded on a different transport when leaving the cross-docking location on the outgoing route.

18. A route graph for describing a plurality of route paths between a plurality of locations, wherein at least one route path in the route graph comprises at least two consecutive direct routes which are connected by a cross-docking location and wherein the at least one route path connects a first location with a second location, wherein
the cross-docking location in combination with the connected at least two direct routes builds up a cross-docking route;
the route graph comprises at least one cross-docking route; and
the at least one route path is specified by the cross-docking route, the first location and the second location.

19. The route graph of claim 18, wherein a cross-docking route describes a local graph of direct routes with respect to the cross-docking location.

20. The route graph of claim 18, wherein at least one direct route is an incoming route with respect to the cross-docking location and at least one direct route is an outgoing route with respect to the cross-docking location.

21. The route graph of claim 20, wherein a plurality of cross-docking routes describe a global graph of direct routes, wherein the plurality of cross-docking routes are connected together.

22. The route graph of claim 21, wherein the incoming route is a cross-docking route.

23. The route graph of claim 22, wherein the outgoing route is a cross-docking route.

24. The route graph of claim 23, wherein a cross-docking route describes a hierarchy of routes, wherein the relationship between a cross-docking route and the incoming and outgoing routes is a parent-child relationship.

25. The route graph of claim 24, wherein a parent within the hierarchy of routes comprises a number of properties and wherein each child with respect to the parent being able to take over the properties of the parent.

26. The route graph of claim 25, wherein each direct route comprises at least one leg, wherein a leg comprises at least a set of locations and a means of transportation.

27. The route graph of claim 26, wherein the first location is a source location of a transportation request and the second location is a destination location of the transportation request.

28. The route graph of claim 27, wherein a route path represents a transportation route from the source location to the destination location of the transportation request.

29. The route graph of claim 28, wherein a cross-docking location is part of several cross-docking routes.

30. The route graph of claim 29, wherein a route is part of several cross-docking routes.

31. The route graph of claim 30, wherein a cross-docking route allows transportation of goods from a source location to a destination location along the transportation route wherein the transportation route comprises at least the cross-docking-route.

32. The route graph of claim 31, wherein a cross-docking route comprises a number of properties for a pair of incoming and outgoing routes indicating whether or not goods on a transportation means arriving at the cross-docking location on the incoming route have to be reloaded on a different transportation means when leaving the cross-docking location on the outgoing route.

33. A computer-implemented method for representing transportation routes in a route graph, comprising:
determining at least one transportation route between a source location S and destination location D using at least one cross-docking route, wherein the at least one cross-docking route describes at least one of a local graph of direct routes and a global graph of direct routes.

34. The computer-implemented method of claim 33, further comprising:
defining a plurality of direct routes;
defining at least one cross-docking location; and
defining at least one cross-docking route by connecting at least two direct routes by the at least one cross-docking location.

35. The computer-implemented method of claim 34, further comprising:
receiving a transportation request comprising at least a source location S and a destination location D; and
issuing a response to the transportation request comprising at least the source location S, the destination location D and a cross-docking route.

36. The computer-implemented method of claim 35, further comprising:
specifying at least one cross-docking route by connecting at least a further cross-docking route by the cross-docking location.

37. The computer-implemented method of claim 36, wherein the determined transportation route comprises a sequence of direct routes.

38. The computer-implemented method of claim 37, further comprising:
maintaining at least one local route graph and maintaining at least one global route graph, wherein an authority for maintaining the at least one local route graph is disjunctive to an authority for maintaining the at least one global route graph.

39. A computer readable medium containing instructions that when executed by a computer causes the computer to:
determine at least one transportation route between a source location S and destination location D using at least one cross-docking route, wherein the at least one cross-docking route describes at least one of a local graph of direct routes and a global graph of direct routes.
